(19) United States
(12) Patent Application Publication
(10) Pub. No.: US 2001/0008097 A1
(43) Pub. Date: Jul. 19, 2001

(54) Rotary apparatus for cutting a food product

(75) Inventor: Michael S. Jacko, Chesterton, IN (US)

Correspondence Address: BACON & THOMAS, PLLC, 4th Floor, 625 Slaters Lane, Alexandria, VA, 22314-1176, US

(73) Assignee: Urschel Laboratories, Inc.

(21) Appl. No.: 09/800,583

(22) Filed: Mar. 8, 2001

Related U.S. Application Data
(63) Continuation of application No. 09/299,648, filed on Apr. 27, 1999.
Application No. 09/299,648 is a continuation of application No. 09/019,701, filed on Feb. 6, 1998, now Pat. No. 5,896,801.
Application No. 09/019,701 is a continuation of application No. 08/653,127, filed on May 24, 1996, now abandoned.
Application No. 08/653,127 is a continuation of application No. 08/250,924, filed on May 31, 1994, now abandoned.

(51) Int. Cl. B26D 3/26

(52) U.S. Cl. 83/356.3; 83/932

(57) ABSTRACT

An apparatus for cutting a food product is disclosed which utilizes a cutting wheel having a plurality of knives extending between a hub and a rim in conjunction with other cutting knives to produce a multi-dimensional cut of the food product. The use of the additional cutting knives enables the apparatus to dice a thin layered or leafy food product (cut it into small pieces) as opposed to merely slicing the food product in a single dimensional cut. The additional cutting knives may include one or more julienne knives attached to each of the knives of the cutting wheel so as to extend approximately at right angles to the cutting plane defined by the cutting wheel knives. A circular knife may be located upstream of the cutting plane defined by the cutting wheel such that the rotary knife longitudinally cuts the food product before it passes through the cutting plane. The apparatus according to the invention also utilizes separate drive motors for the feed conveyor and for the cutting wheel. In order to prevent deflection or deformation of the larger cutting wheel, a rim stabilizer engages the cutting wheel rim to prevent any deflection of the rim which, may cause deflection of the cutting knives, as the cutting wheel rotates.

### BACKGROUND OF THE INVENTION

The present invention relates to an apparatus for cutting a food product, more particularly, such an apparatus utilizing a rotatable cutting wheel having a plurality of generally radial slicing knives which define a cutting plane.

Known devices for slicing a food product typically comprise a rotatable slicing wheel having a plurality of knives extending between a hub and a rim so as to define a cutting plane and a conveying device for conveying the food product through the cutting plane. The speed of the feed device and the rotating speed of the cutting wheel are synchronized such that the food product is sliced into substantially uniform thickness slices. While generally successful, these known slicing machines have been heretofore limited to cutting the food product into slices and have been somewhat limited in the overall size of the food product which may be accommodated. The known food slicing devices also utilize a single motor to drive both the food product feed conveyor and the rotating cutting wheel. While the use of a single motor promotes accurate synchronization of the feed means and the cutting wheel speed, it results in a complicated drive arrangement requiring numerous lubrication points and increased maintenance.

The known slicing machines have been found inadequate for slicing food products such as Iceberg and Romaine lettuce. It has been necessary to precut the lettuce heads into halves or quarters before feeding them into the known slicing machines which are capable of making only a single dimension slicing cut. Thus, the known slicing machines have been utilized only to make shredded lettuce. The lettuce food products may be diced on a known dicing type of dicing apparatus, however, the size of the food product is, again, limited and the known devices are capable of producing only approximately 4,000 lbs. of food product per hour of operation. In order to properly dice a food product, such as lettuce, it is necessary for the apparatus to provide more than a one dimensional cut. This requirement has heretofore rendered the known slicing devices to be inappropriate for dicing food products.

### SUMMARY OF THE INVENTION

An apparatus for cutting a food product is disclosed which utilizes a cutting wheel having a plurality of knives extending between a hub and a rim in conjunction with other cutting knives to produce a multi-dimensional cut of the food product. The use of the additional cutting knives enables the apparatus to dice a thin layered or leafy food product (cut it into small pieces) as opposed to merely slicing the food product in a single dimensional cut. The additional cutting knives may include one or more julienne knives attached to each of the knives of the cutting wheel so as to extend approximately at right angles to the cutting plane defined by the cutting wheel knives. Also, a circular knife may be located upstream of the cutting plane defined by the cutting wheel such that the rotary knife longitudinally cuts the food product before it passes through the cutting plane. The combination of the cutting knives enables this apparatus to dice a food product, such as lettuce, causing minimal bruising to the food product, thereby extending its shelf life.

The apparatus according to the invention also utilizes separate drive motors for the feed conveyor and for the cutting wheel. The use of separate drive motors eliminates the complicated drive mechanism of the known devices and enables the size of the apparatus to be increased so as to accommodate larger sized food products. The device of the present invention is capable of dicing approximately 15,000 lbs./hour of Iceberg lettuce, a significantly greater capacity than the known dicing machines.

In order to prevent deflection or deformation of the larger cutting wheel, a rim stabilizer engages the cutting wheel rim to prevent any deflection of the rim which, may cause deflection of the cutting knives, as the cutting wheel rotates. The rim stabilizer has one or more rotatable rollers which engage a groove defined in the rim of the cutting wheel so as to prevent any deflection in directions on either side of the cutting plane. The rim stabilizer may be moved out of engagement with the rim in order to facilitate removal or installation of the cutting wheel on the apparatus. Increased size of the apparatus, including the increased diameter cutting wheel, enables the apparatus to accept a food product of approximately 6½ inches or more in diameter as contrast to the maximum diameter food product of 2¾ inches for the know slicing devices.

### BRIEF DESCRIPTION OF THE DRAWINGS

FIG. 1 is a partial, end view of a known food slicing device.

FIG. 2 is a partial, perspective view of the cutting wheel used in the known slicing device.

FIG. 3 is a partial, perspective view of the cutting apparatus according to the present invention.

FIG. 4 is a partial, perspective view of the cutting wheel according to a first embodiment of the present invention.

FIG. 5 is a partial, perspective view of a cutting wheel according to a second embodiment of the present invention.

FIG. 6 is a partial, end view of a cutting apparatus according to the present invention illustrating the cutting wheel of FIG. 4.

FIG. 7 is a partial, perspective view of the cutting device according to the present invention incorporating a single circular cutting knife.

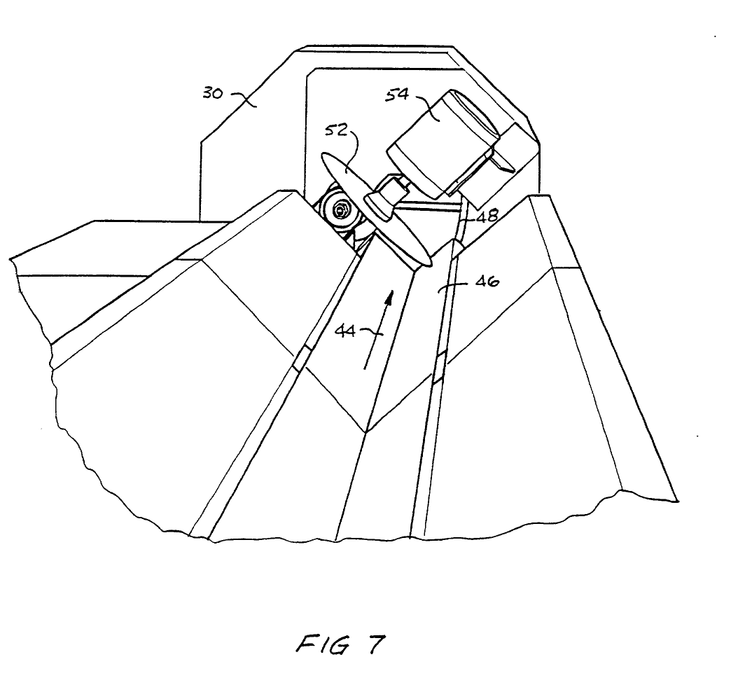

FIG. 8 is a view similar to FIG. 7, but illustrating the use of multiple circular knives.

FIG. 9 is a partial view of a rim stabilizing device utilized with the present invention.

FIG. 10 is a partial, enlarged view of the rim stabilizer illustrated in FIG. 9.

FIG. 11 is a partial, perspective view illustrating the cutting apparatus according to the present invention utilized with a top feed belt.

### DETAILED DESCRIPTION OF THE PREFERRED EMBODIMENTS

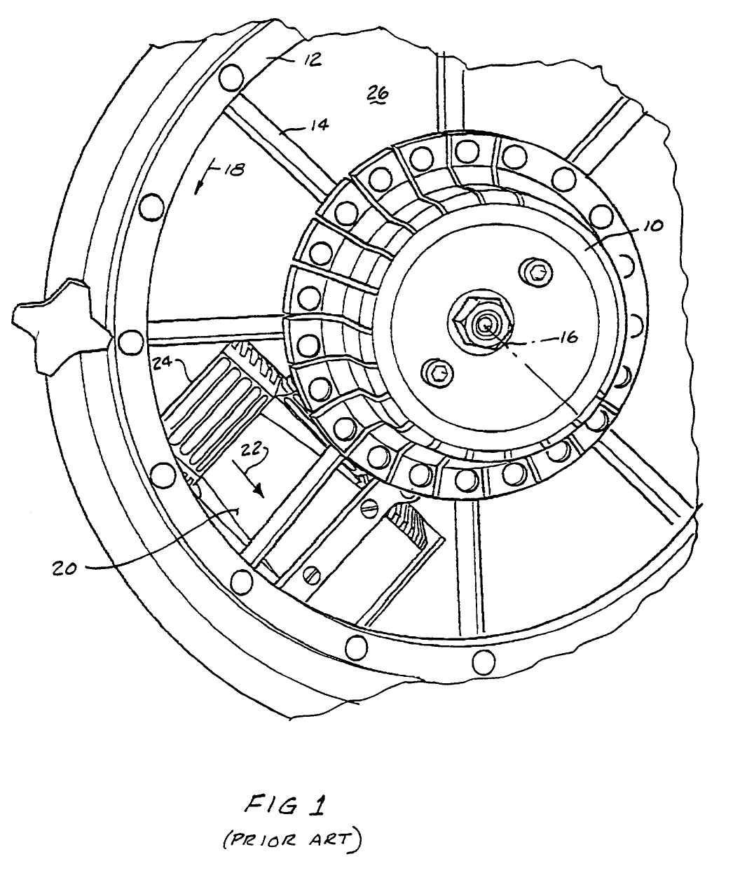

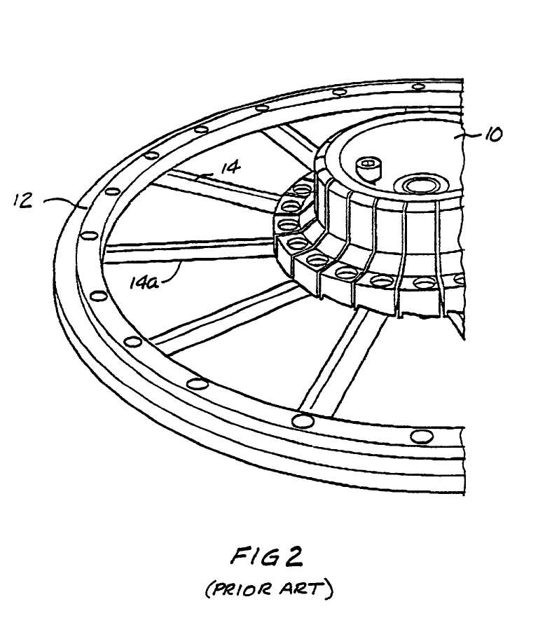

FIGS. 1 and 2 illustrate a cutting wheel of a known food slicing apparatus, such as the devices illustrated in U.S. Pat. Nos. 2,482,523 and 3,004,572. The cutting wheel comprises a hub 10 and a rim 12 interconnected by a plurality of knives 14. The cutting wheel is rotated about an axis 16 in the direction of arrow 18 while the food to be sliced is transported by conveyor 20 in the direction of arrow 22. The food product passes through opening 24 in support structure 26 and is sliced by the blades 14 into uniform slices. The cutting wheel is shown in a partial perspective view in FIG. 2. As can be seen, the knives 14 are generally planar in configuration extending generally radially between hub 10 and rim 12 and may have sharpened edge portions 14a.

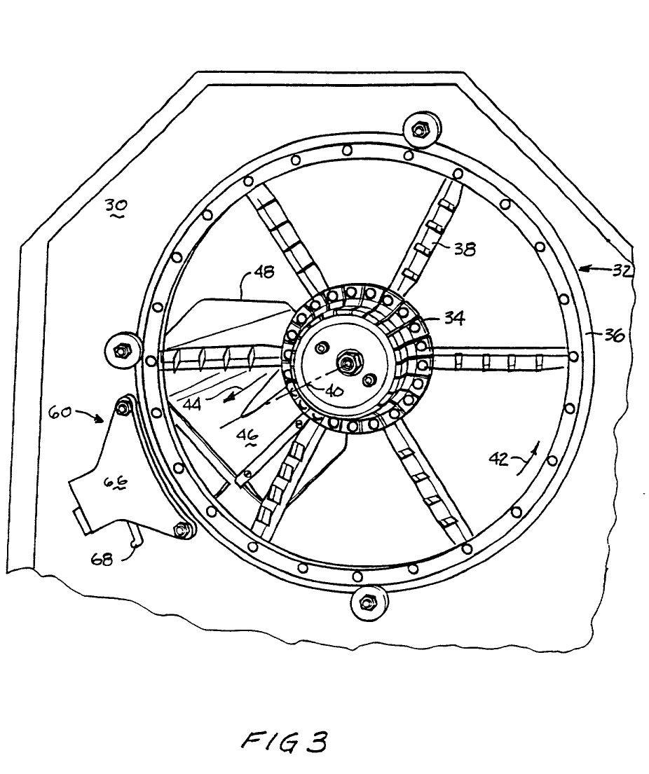

The cutting apparatus according to the present invention is illustrated in FIG. 3 and comprises a support structure 30 which rotatably supports a cutting wheel 32 comprising a hub 34, a rim 36 and a plurality of knives 38 which interconnect the hub and rim, and which may extend generally radially from the hub. The cutting wheel 32 rotates about axis 40 in the direction of arrow 42 by a connection to a drive motor which is used to only drive the cutting wheel 32.

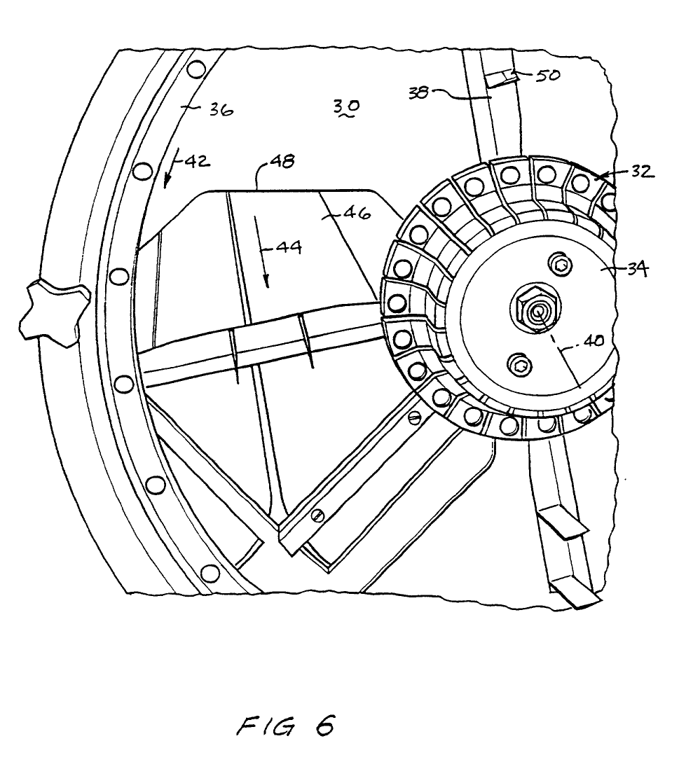

As shown in FIGS. 3 and 6, the food product is conveyed in the direction of arrow 44 by conveyor 46 such that it passes through opening 48 in the support structure 30 and through a cutting plane defined by the cutting knives 38 as they rotate about axis 40.

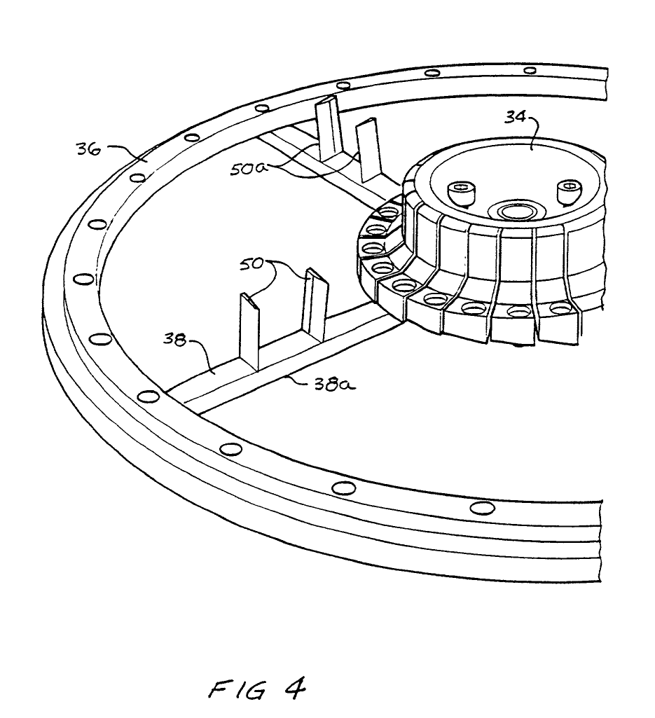

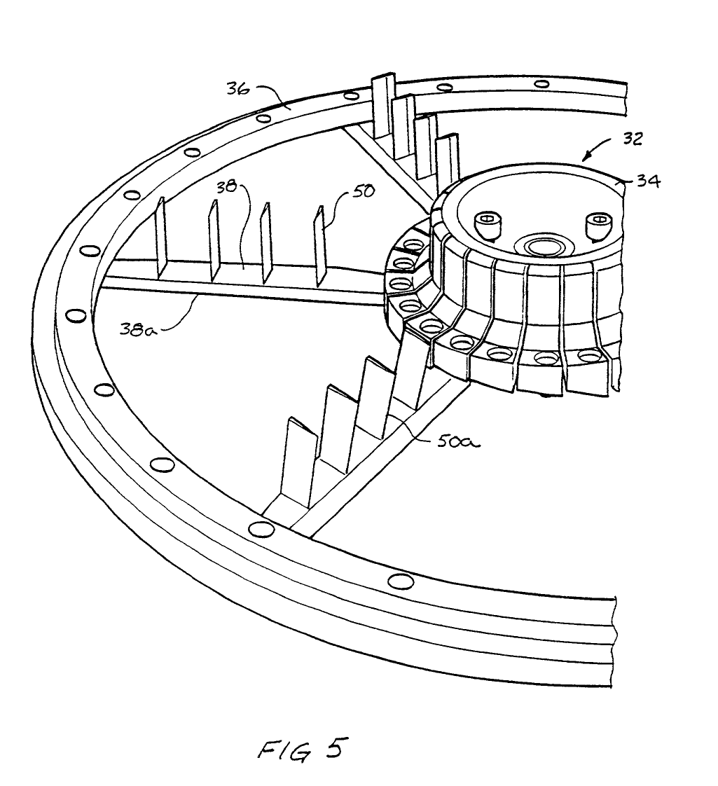

As illustrated in FIGS. 4 and 5, the cutting wheel according to the present invention may have one or more julienne knives 50 extending generally perpendicularly from the plane of the knives 38. The julienne knives 50 may have sharpened cutting edges 50a and knives 38 may have sharpened edges 38a. Julienne knives 50 may be attached to the knives 38 by brazing or the like. As illustrated in FIGS. 4 and 5, different numbers of julienne knives 50 may be attached to the knives 38 depending upon the desired size of the final cut product. As the food product passes through the opening 48 in the support structure 30, it is not only cut in one direction by knives 38, but it is also cut in a perpendicular direction by the julienne knives 50. Thus, the present invention may impart a multi-dimensional cut to the food product as opposed to the single dimensional cut imposed by the known slicing apparatus.

In order to dice some food products, it may also be desirable to incorporate an additional knife upstream of the cutting plane of the cutting wheel 32. This may take the form of a circular knife 52 rotated by drive motor 54 which is stationarily attached to the support structure 30. Use of the circular knife 52 in conjunction with the julienne knives 50 attached to the knives 38 has resulted in a diced food product, such as Iceberg lettuce, equal to the quality of the known dicing apparatus, but attainable at a significantly higher quantity. Known dicing machines are capable of dicing approximately 4,000 lbs. of lettuce per hour while the present invention is capable of dicing approximately 15,000 lbs. of lettuce per hour assuming that the lettuce heads are spaced approximately three feet apart on the feed conveyor 46.

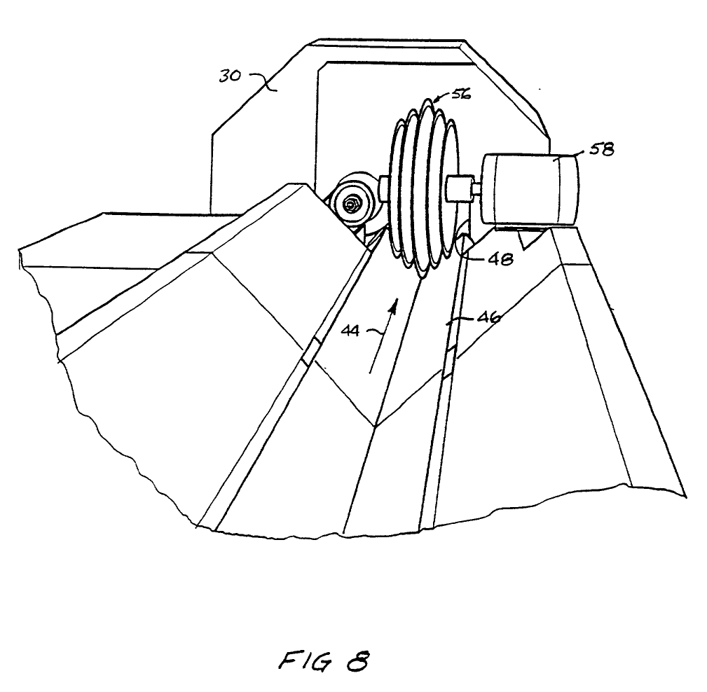

It is also possible to utilize a plurality of circular knives to impart a plurality of longitudinal cuts to the food product before it passes through the slicing plane of the cutting wheel 32. This is illustrated FIG. 8 wherein a plurality of generally parallel circular knives 56 are rotated by motor 58 which is, again, attached to stationary support structure 30.

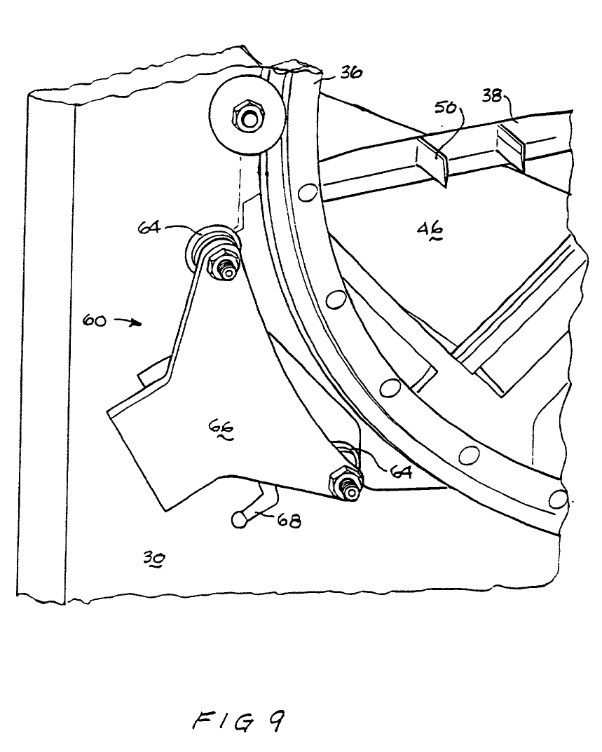

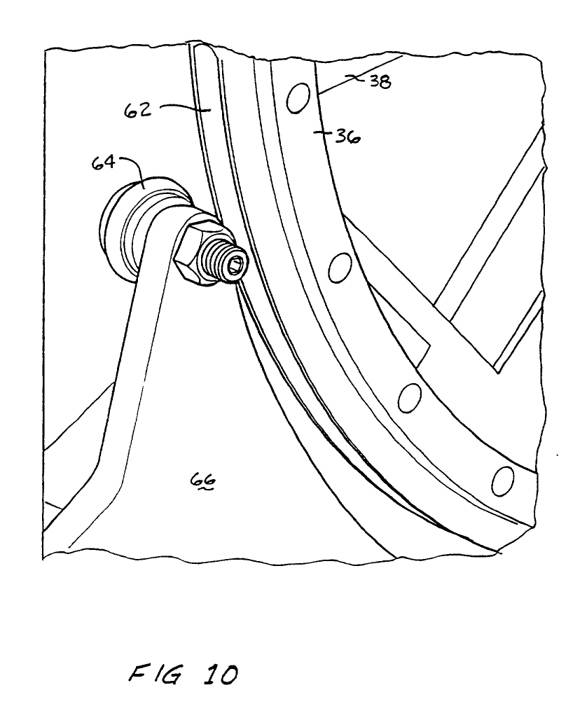

As noted previously, the conveyor 46, which may be either a double endless belt, V-shaped conveyor, or a flat endless conveyor belt, is powered by a motor drive means which is completely separate from the motor drive means rotating the cutting wheel 32. The structure of the present cutting apparatus is significantly larger than the known slicing machines which enables it to cut a larger size of food product at a higher capacity than the known devices. However, the significantly larger diameter of the cutting wheel 32 may allow deflection from the cutting plane which will cause the food product to be improperly cut, or possibly cause damage to the cutting wheel itself by contact with the stationary structure. In order to avoid this possibility, the cutting apparatus may include a rim stabilizer 60 illustrated in FIGS. 3, 9 and 10. The rim 36 of the cutting wheel 32 defines a circumferential, curved groove 62 about its outer periphery which is engaged by rollers 64 rotatably attached to rim stabilizer body 66. Rim stabilizer body 66 may be movably attached to the stationary support structure 30 via a lockable dovetail slide mechanism such that it may be moved to a position wherein the rollers 64 are disengaged from the groove 62. This facilitates removable of the cutting wheel 32 from the apparatus. The rim stabilizer 60 may be locked in its stabilizing position, in which the rollers 64 engage the groove 62 by known locking means actuated by lever 68.

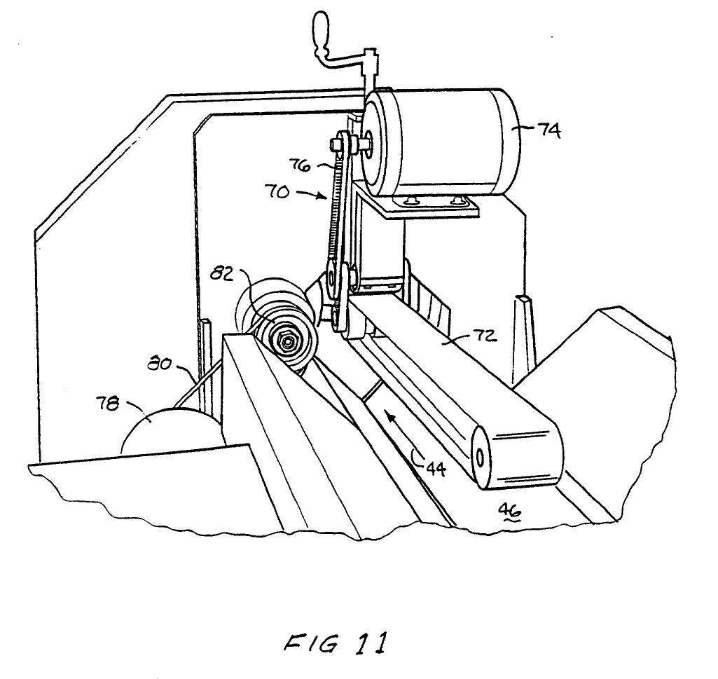

As illustrated in FIG. 11, the present invention may also utilize a top feed conveyor assembly 70 which comprises a top endless conveyor belt 72 driven by motor 74 via belt drive 76. This drive mechanism may be utilized under certain conditions wherein it is desired to impart a greater degree of stability to the food product as it is conveyed to the cutting plane. FIG. 11 also illustrates the drive motor 78 for rotating the cutting wheel 32. This may be achieved by drive belt 80 which passes around a drive pulley driven by the motor 78 and a driven pulley 82 which, by known means, is attached to the cutter wheel drive shaft. Motor 78 is separate from the motor (not shown) which powers conveyor 46 and from that which powers conveyor belt 72. This avoids the necessity of using a complicated drive transfer mechanism of the known slicing devices.

The foregoing description is provided for illustrative purposes only and should not be construed as in any way limiting this invention, the scope of which is defined solely by the appended claims.

1. Apparatus for cutting a food product comprising:
a) a cutting wheel having a hub, a rim, a plurality of first knives extending from the hub so as to interconnect the hub and the rim and define a first cutting plane, and at least one second knife attached to and extending generally perpendicularly from at least one first knife;
b) first drive means to rotate the cutting wheel about an axis extending substantially perpendicular to the first cutting plane; and,
c) feed means to feed a food product into the first cutting plane of the cutting wheel.

2. The cutting apparatus of claim 1 wherein each first knife in the cutting wheel has at least one second knife extending generally perpendicularly therefrom.

3. The cutting apparatus of claim 1 wherein the feed means feeds the food product into the first cutting plane from a first side thereof and wherein the at least one second knife extends from a second side of the first cutting plane.

4. The cutting apparatus of claim 1 wherein the feed means comprises conveying means to transport the food product from a loading area into the first cutting plane.

5. The cutting apparatus of claim 4 wherein the conveying means comprises:
a) an endless belt conveyor; and,
b) second drive means to drive the endless belt conveyor.

6. The cutting apparatus of claim 1 further comprising a third knife means located adjacent to the feed means so as to cut the food product before it reaches the cutting plane.

7. The cutting apparatus of claim 6 wherein the third knife means comprises at least one circular knife.

8. The cutting apparatus of claim 7 wherein the at least one circular knife lies in a second cutting plane extending substantially perpendicular to the first cutting plane.

9. The cutting apparatus of claim 7 further comprising third drive means to rotate the at least one circular knife.

10. The cutting apparatus of claim 6 wherein the third knife means comprises a plurality of circular knives.

11. The cutting apparatus of claim 1 further comprising:
a) a stationary support;
b) means to rotatably support the cutting wheel on the stationary support; and,
c) rim stabilizing means attached to the stationary support and in contact with the rim of the cutting wheel to prevent deflection of the cutting wheel rim.

12. The cutting apparatus of claim 11 wherein the rim stabilizing means comprises:
a) a groove defined by the cutting wheel rim;
b) a rim stabilizer body attached to the stationary support; and,
b) at least one roller attached to the rim stabilizer body so as to engage the groove.

13. The cutting apparatus of claim 12 further comprising means to movably attach the rim stabilizer body to the stationary support such that the rollers may be moved out of engagement with the groove in the cutting wheel rim.

14. The cutting apparatus of claim 11 further comprising a third knife means located adjacent to the feed means so as to cut the food product before it reaches the cutting plane.

15. The cutting apparatus of claim 14 wherein the third knife means comprises at least one circular knife.

16. The cutting apparatus of claim 15 wherein the at least one circular knife lies in a second cutting plane extending substantially perpendicular to the first cutting plane.

17. The cutting apparatus of claim 14 wherein the third knife means comprises a plurality of circular knives.

18. The cutting apparatus of claim 15 further comprising third drive means to rotate the at least one circular knife.

19. The cutting apparatus of claim 14 wherein the feed means comprises conveying means to transport the food product from a loading area into the first cutting plane.

20. The cutting apparatus of claim 19 wherein the conveying means comprises:
a) an endless belt conveyor; and,
b) second drive means to drive the endless belt conveyor.

21. Apparatus for cutting a food product comprising:
a) a cutting wheel having a hub, a rim and a plurality of first knives extending from the hub so as to interconnect the hub and the rim and defining a first cutting plane;
b) first drive means to rotate the cutting wheel about an axis extending substantially perpendicular to the first cutting plane;
c) feed means to feed a food product into the first cutting plane; and,
d) a second knife means located adjacent to the feed means so as to cut the food product before it reaches the first cutting plane.

22. The cutting apparatus of claim 21 wherein the second knife means comprises at least one circular knife.

23. The cutting apparatus of claim 22 wherein the at least one circular knife lies in a second cutting plane extending substantially perpendicular to the first cutting plane.

24. The cutting apparatus of claim 22 further comprising second drive means to rotate the at least one circular knife.

25. The cutting apparatus of claim 21 wherein the second knife means comprises a plurality of circular knives.

26. The cutting apparatus of claim 25 wherein the plurality of circular knives are substantially parallel to each other.

27. The cutting apparatus of claim 24 wherein the feed means comprises conveying means to transport the food product from a loading area into the first cutting plane.

28. The cutting apparatus of claim 27 wherein the conveying means comprises:
a) an endless belt conveyor; and,
b) third drive means to drive the endless belt conveyor.

29. The cutting apparatus of claim 21 further comprising:
a) a stationary support;
b) means to rotatably support the cutting wheel on the stationary support; and,
c) rim stabilizing means attached to the stationary support and in contact with the rim of the cutting wheel to prevent deflection of the cutting wheel rim.

30. The cutting apparatus of claim 29 wherein the rim stabilizing means comprises:
a) a groove defined by the cutting wheel rim;
b) a rim stabilizer body attached to the stationary support; and,
b) at least one roller attached to the rim stabilizer body so as to engage the groove.

31. The cutting apparatus of claim 30 further comprising means to movably attach the rim stabilizer body to the stationary support such that the rollers may be moved out of engagement with the groove in the cutting wheel rim.

32. The cutting apparatus of claim 31 wherein the feed means comprises conveying means to transport the food product from a loading area into the first cutting plane.

33. The cutting apparatus of claim 32 wherein the conveying means comprises:
a) an endless belt conveyor; and,
b) second drive means to drive the endless belt conveyor.

34. The cutting apparatus of claim 21 wherein the feed means comprises conveying means to transport the food product from a loading area into the first cutting plane.

35. The cutting apparatus of claim 34 wherein the conveying means comprises:
a) an endless belt conveyor; and,
b) second drive means to drive the endless belt conveyor.

36. Apparatus for cutting a food product comprising:
a) a cutting wheel having a hub, a rim and a plurality of knives extending from the hub so as to interconnect the hub and the rim and define a cutting plane;
b) first drive means to rotate the cutting wheel about an axis extending substantially perpendicular to the cutting plane;
c) feed means to feed a food product into the cutting plane;
d) a stationary support; and,
e) rim stabilizing means attached to the stationary support and in contact with the rim of the cutting wheel to prevent deflection of the cutting wheel rim.

37. The cutting apparatus of claim 36 wherein the rim stabilizing means comprises:
a) a groove defined by the cutting wheel rim;
b) a rim stabilizer body attached to the stationary support; and,
b) at least one roller attached to the rim stabilizer body so as to engage the groove.

38. The cutting apparatus of claim 37 further comprising means to movably attach the rim stabilizer body to the stationary support such that the rollers may be moved out of engagement with the groove in the cutting wheel rim.

39. The cutting apparatus of claim 36 wherein the feed means comprises conveying means to transport the food product from a loading area into the first cutting plane.

40. The cutting apparatus of claim 39 wherein the conveying means comprises:
a) an endless belt conveyor; and,
b) second drive means to drive the endless belt conveyor.
